(19) United States
(12) Patent Application Publication
(10) Pub. No.: US 2013/0207319 A1
(43) Pub. Date: Aug. 15, 2013

(54) METHOD AND DEVICE FOR BLOW MOULDING CONTAINERS

(71) Applicants: Frank Haesendonckx, Hamburg (DE); Marco Bohnke, Mollagen (DE); Dieter Klatt, Hamburg (DE); Rolf Baumgarte, Ahrensburg (DE); Carlo Striebel, Hamburg (DE); Gerhard Klopper, Hamburg (DE); Michael Litzenberg, Geesthacht (DE); Frank Lewin, Tangstedt (DE)

(72) Inventors: Frank Haesendonckx, Hamburg (DE); Marco Bohnke, Mollagen (DE); Dieter Klatt, Hamburg (DE); Rolf Baumgarte, Ahrensburg (DE); Carlo Striebel, Hamburg (DE); Gerhard Klopper, Hamburg (DE); Michael Litzenberg, Geesthacht (DE); Frank Lewin, Tangstedt (DE)

(73) Assignee: KHS CORPOPLAST GMBH, Hamburg (DE)

(21) Appl. No.: 13/878,908

(22) PCT Filed: Oct. 13, 2011
(86) PCT No.: PCT/DE11/01859

§ 371 Date: May 1, 2013

(30) Foreign Application Priority Data
Oct. 13, 2010 (DE) 10 2010 048 663.9

(51) Int. Cl. B29D 22/00

(52) U.S. Cl. CPC B29D 22/003
USPC 264/530; 425/541

(57) ABSTRACT

The method and the device are used to blow mould containers. A parison is transformed into the container after thermal conditioning within a blow mould of a blow moulding machine by the action of blowing pressure. In order to adjust to a contour of the container to be produced, prior to the moulding of the container, at least a part of a first blow mould is first removed from the blow station and replaced by at least a part of a second blow mould. Betbre the part of the first blow mould is removed, a locking device which fixes this part in the blow station is released and after the insertion of the part of the second blow mould said locking device is again positioned for fixing the part of the second blow mould. Each locking device is coupled to an operating element.

The invention relates to a method for blow molding of containers, in which within a blow mold of a blowing station of a blow molding machine preforms after their thermal conditioning are reshaped into the container by blowing pressure, and where for the adjustment to a contour of the container to be produced, first at least a part of a first blow mold is removed from the blowing station and replaced by at least a part of a second blow mold, and wherein before removal of the part of the first blow mold, a fastening that fixes this part of the blow mold is unlocked, and after insertion of the part of the second blow mold, said fastening is again positioned for fixing the part of the second blow mold.

In addition the invention relates to a device for blow molding of containers that exhibits at least one blowing station with a blow form, as well with the blow mold consisting of at least two parts, that can be fixed by at least one fastening in the area of the blowing station, wherein the fastening is coupled with at least one actuating mechanism.

In the formation of containers through blowing pressure, preforms made of a thermoplastic material, for example preforms made of PET (polyethylene terephthalate), are fed within a blowing machine to various processing stations. Typically such a blowing machine exhibits a heating device and a blowing device, in the area of which the previously tempered preform is expanded through biaxial orientation into a container. The expansion occurs with the aid of compressed air which is injected into the preform to be expanded. The procedure with such an expansion of the preform is explained in DE-OS 43 40 291. The injection of pressurized gas, mentioned at the outset, also comprises compressed gas injection into the developing container bubble as well as compressed gas injection into the preform at the start of the blowing process.

The basic design of a blowing station for forming containers is described in DE-OS 42 12 583. Possibilities for heat-treating the preforms are explained in DE-OS 23 52 926.

Within the device for blow forming, the preforms as well as the blown-up containers can be transported with the aid of various handling devices. The use of transport mandrels, on which the preforms can be placed, has proven itself in particular. However, the preforms can also be handled by other carrying devices. Use of gripping tongs for handling preforms and the use of expanding mandrels which can be inserted for securing in a mouth area of the preform, also are among the available designs.

Handling the containers while using transfer wheels is described, for example, in DE-OS 199 06 438 for an arrangement of the transfer wheel between a blow wheel and an output segment.

The preforms are handled, as already explained, in a so-called dual-stage procedure, in which the preforms first are produced in an injection molding procedure, then placed in intermediate storage, and only later heat-treated and blown up into a container. Or, a so-called single-stage procedure is used, in which the preforms are suitably heat-treated immediately after being manufactured by injection molding and a sufficient solidification and then are blown up.

In regard to the blowing stations used, various embodiment forms are known. With blowing stations that are arranged on rotating transport wheels, it is often seen that the form carriers can be opened up in book fashion. But it is also possible to use form carriers that can be slid relative to each other or guided by some other means. With positionally fixed blowing stations that are especially well suited to admit multiple cavities for forming containers, typically plates are used as form carriers, arranged parallel to each other.

High-capacity blowing machines exhibit a considerable output of bottles per unit of time. With machines having such productive capacities, this output currently can reach up to an order of magnitude of about 80,000 bottles per hour.

With many applications, the operator of such a blowing machine makes various end products, and for it needs variously shaped blown containers. Therefore, the overall output capacity of high-capacity machines over several days often exceeds the specific demand for a certain number of blown containers. Therefore, the blowing stations of blowing machines are constructed so that the blow forms can be changed out in part or as a whole. After such a changeover, the blowing machine in question can then produce containers that are shaped differently or have different dimensions.

Especially with large blowing machines, which often exhibit 20 to 40 blowing stations, which are arranged on a rotating blow wheel, changeover of blow molds or of parts of blow molds proves to be labor-intensive.

A typical design of blowing stations is such that initially they exhibit mechanically relatively stable exterior form carriers, which, depending on the design, can be locked against each other, or which can be used unlocked. In these outer form carriers, often exterior shell molds are used, which are of a relatively universal design and as a rule are not replaced even when a form is changed. In addition, interior shell molds are used which possess an inner contour that is adjusted to the container to be manufactured. These interior shell molds are then detachably fixed in the area of the exterior shell molds.

One typical such design is described in EP 0 821 641 A. Here the exterior shell molds are screw-connected with the form carriers, and movable lashes are placed in lateral areas of the exterior shell molds. When the interior shell molds are changed out, the screws securing the lashes are loosened, and the lashes are shifted outwards. Then the particular interior shell mold can be removed and changed out by another shell mold. Then the lashes again are shifted inwards and again secured. After a blowing station is opened, thus four screws must be loosened in the area of each blowing station, four lashes must be shifted, and then re-positioned again and then the four screws are again tightened.

A fastening device that is substantially simplified as regards handling is described in WO 2007/12308. Here, using a manual lever, a fastening is released and again fixed, which provides both a form-locking and a force-locking. With use in a design with interior shell molds and with exterior shell molds, an entire side of the interior shell mold can be released relative to the exterior shell mold in one operational step, or again fixed.

In regard to making production down-times due to mold changeouts as brief as possible, the previously known processes and devices cannot meet all the requirements set for minimizing changeout time.

Therefore the object of the present invention is to improve a method of the type mentioned initially, to reduce changeout time when a form changeout process is carried out.

This problem is solved according to the invention in that every fastening device is coupled with an adjusting element.

A further object of the present invention is to design a device of the type named initially so that changeout times can be reduced when a form is changed.

This problem is solved according to the invention in that every fastening device is coupled with an adjusting element.

Owing to the coupling of each fastening device used with an adjusting element, it is possible to change out the form without using tools. Depending on the particularly automation stage desired, it is possible to configure all or some of the adjusting elements as manually operable levers or handles. In a more heavily automated embodiment form, at least some of the adjusting elements can be implemented as actuators, for example as pneumatically or hydraulically activated cylinders or as electric motors.

The particular embodiment forms to be implemented are selected depending on a specifically desired reduction in changeout times and in dependence on expense for devices viewed as justifiable.

In one economical version of facilitation of form changeout without tools, all the adjusting elements are implemented as manually operable elements, while with a very extensive automation, as large as possible a number of the adjusting elements are designed as actuators, which preferably can be operated from a control device of the machine. However, mixed usage may be made of both manually operated controls and controllable actuators.

The mechanical sequences can be advantageously coordinated in connection with a loosening of the fastening device in that before loosening of the fastening, the blowing station is opened.

The motion can be made to be repeatable and robust in that the blowing station is opened during a turning movement of the blow wheel through a curved segment capable of being positioned.

For further preparation of a required working space, it is recommended that a blowing nozzle be positioned before unlocking the fastening.

One appropriate structural implementation consists in positioning the blow nozzle during a turning motion of the blowing wheel through a curved segment.

For further adaptation to the container to be produced, it is suggested that a fastening of a base form be released.

The required operating time can be further reduced by having the base form be connected via at least one coupling with at least one operating-material supply.

A simplified mechanical design is made available in that a support for the base form is mechanically coupled with form carriers of the blowing station so that a motion-coupling is implemented.

One economical embodiment form can be achieved in that the adjusting element is manually controlled.

An intensified degree of automation is facilitated in that the adjusting element is operated by a controllable actuator.

The drawings are schematic depictions of embodiment examples of the invention.

Shown are:

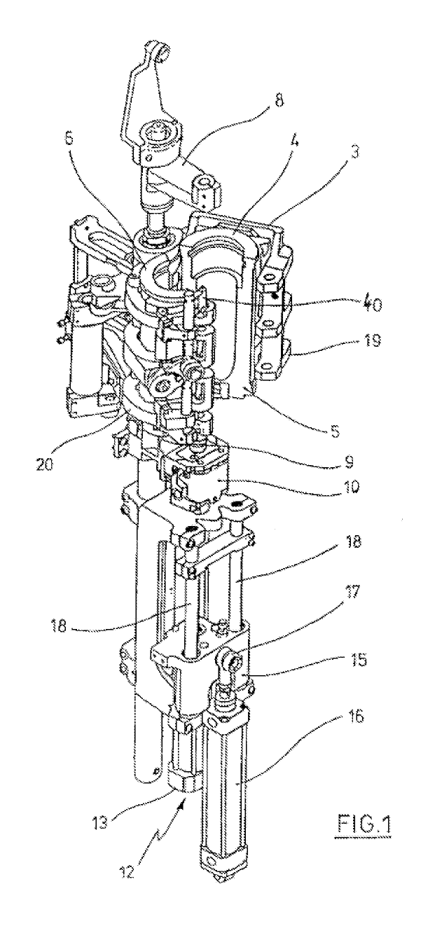

FIG. 1 A perspective view of a blowing station for production of containers from preforms.

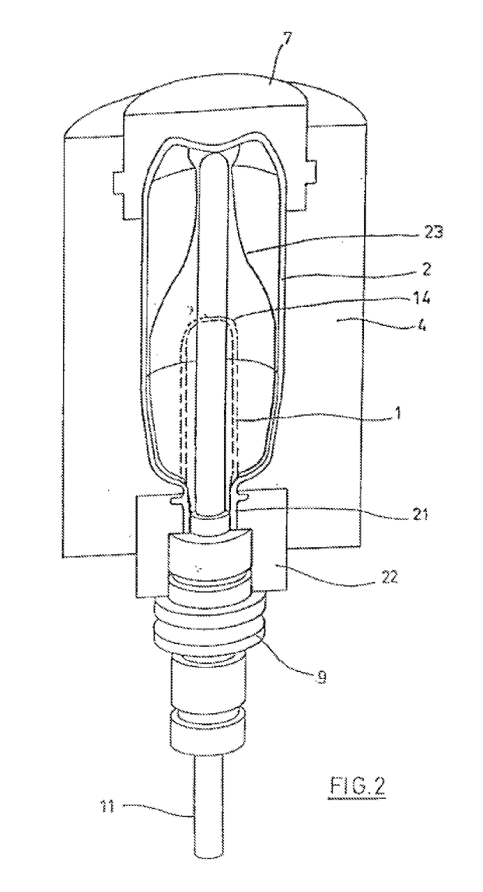

FIG. 2 A longitudinal section through a blow mold, in which a preform is stretched and expanded.

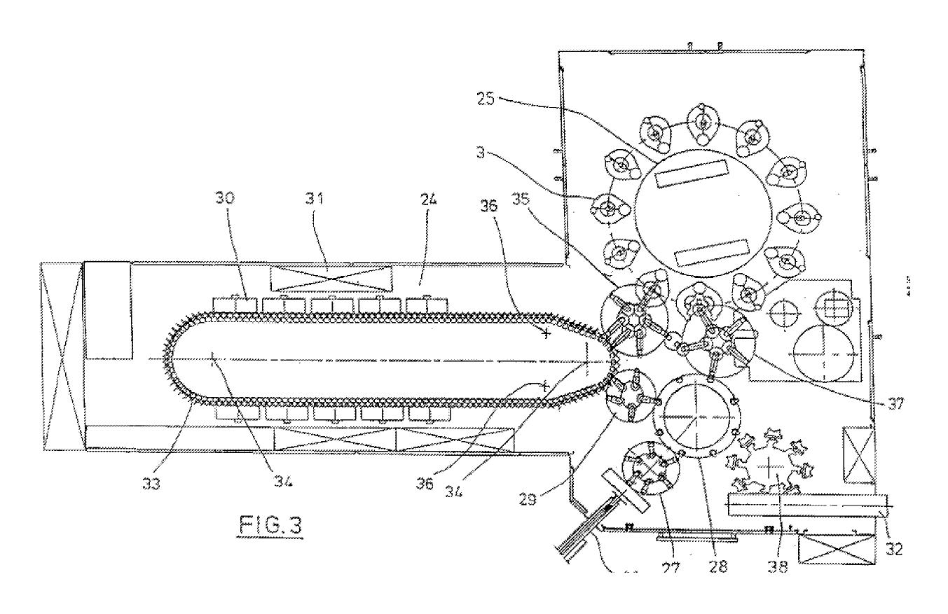

FIG. 3 A sketch to clarify a basic design of a device for blow forming of containers.

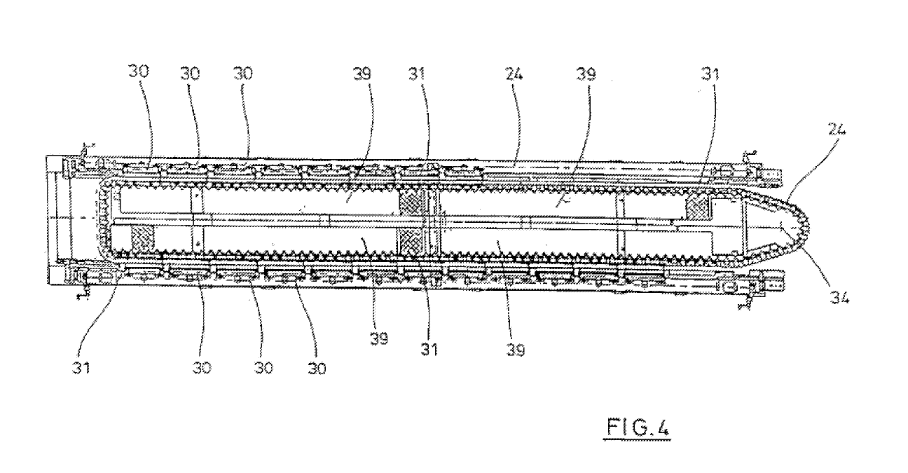

FIG. 4 A modified heating section with an expanded heating capacity.

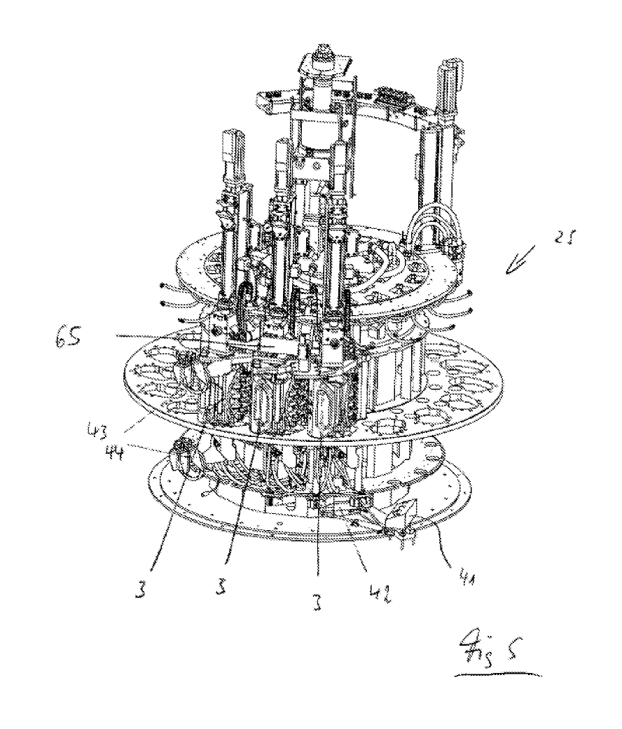

FIG. 5 A perspective view of a blow wheel with some mounted blowing stations as well as a separate control device to facilitate form changeout without tools

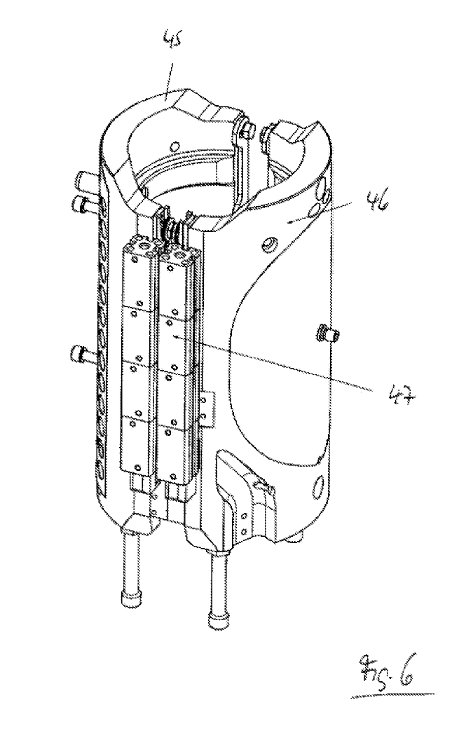

FIG. 6 A perspective view of exterior shell molds with actuators for operating a fastening for fixing of interior shell molds not depicted.

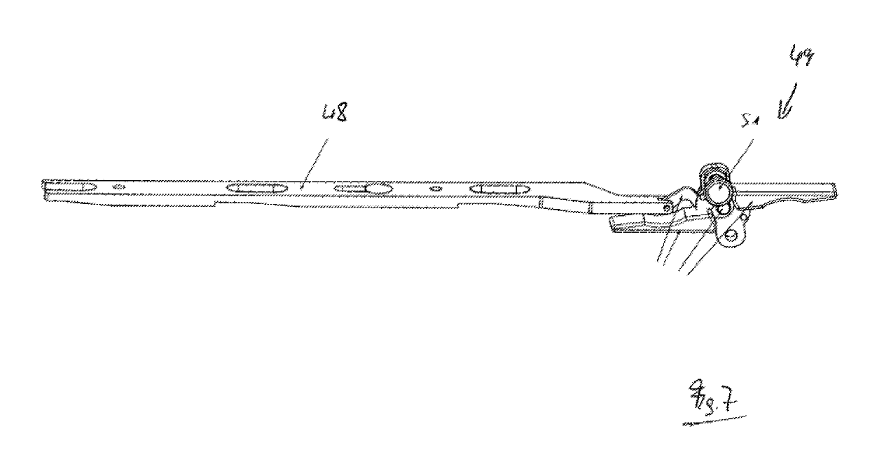

FIG. 7 A manually operable fastening element for fixing and release of interior shell molds.

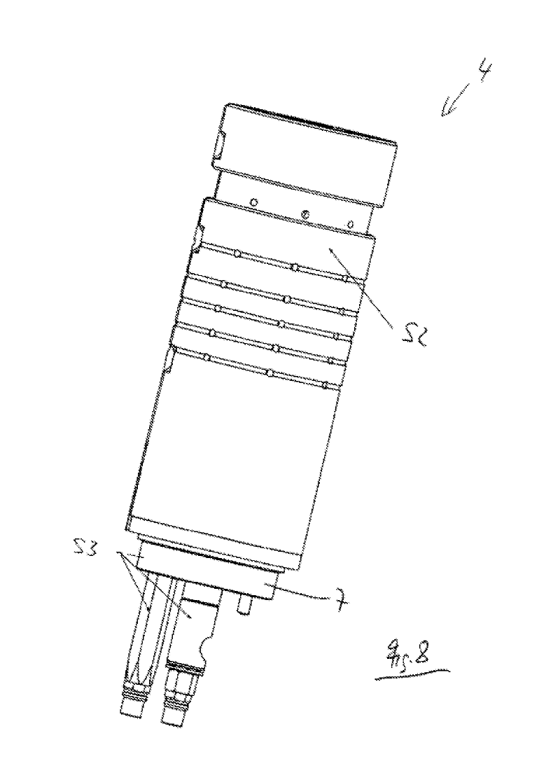

FIG. 8 An exterior view in perspective of an exterior shell mold.

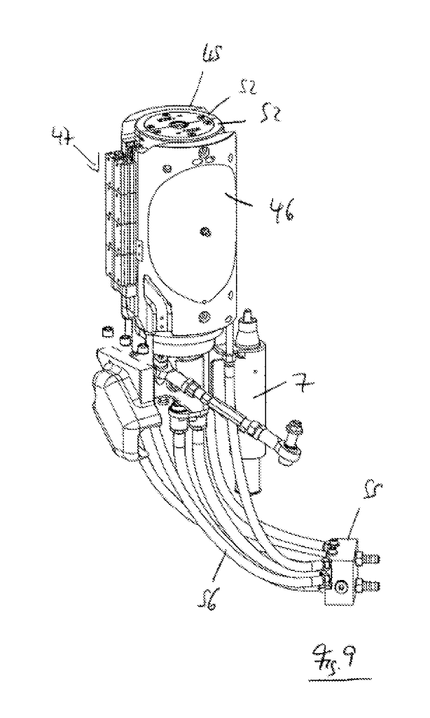

FIG. 9 A perspective view of exterior shell molds with inserted interior shell molds.

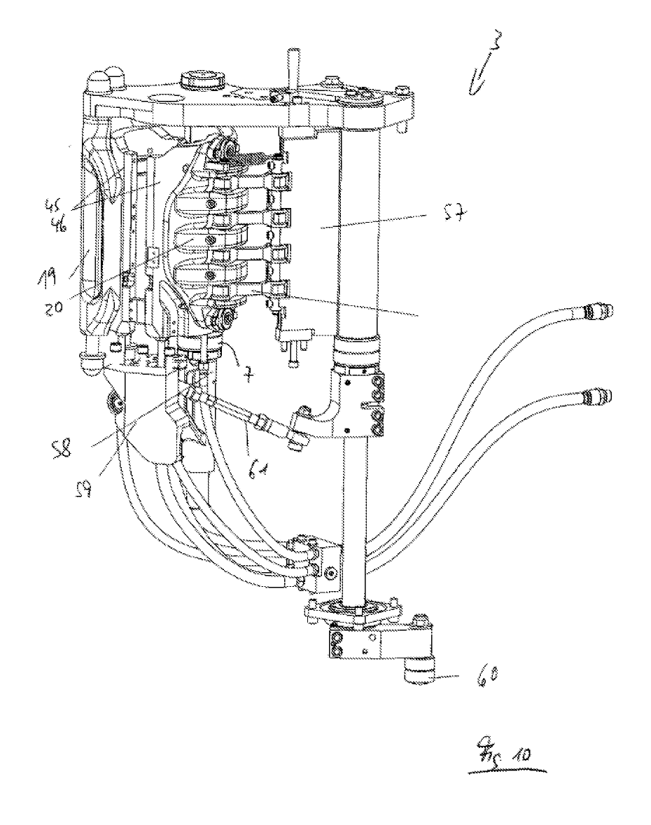

FIG. 10 A perspective view of a device for positioning of a base form.

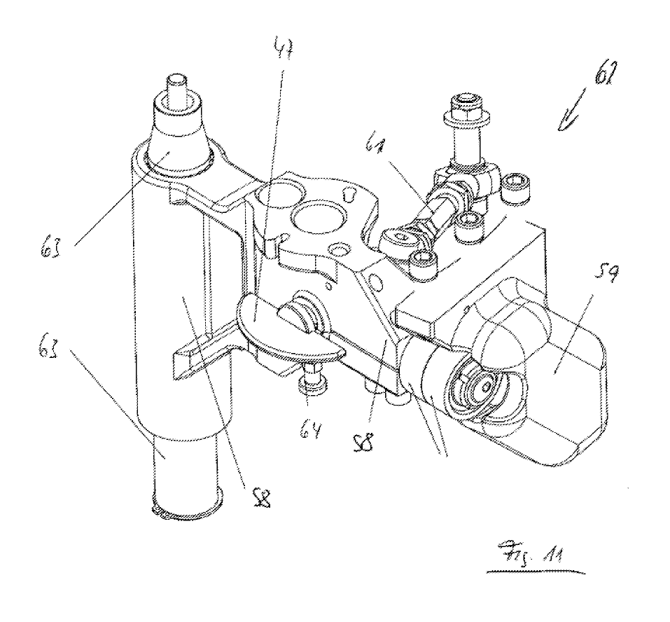

FIG. 11 A fastening for a base form, wherein the fastening is equipped with a manual lever.

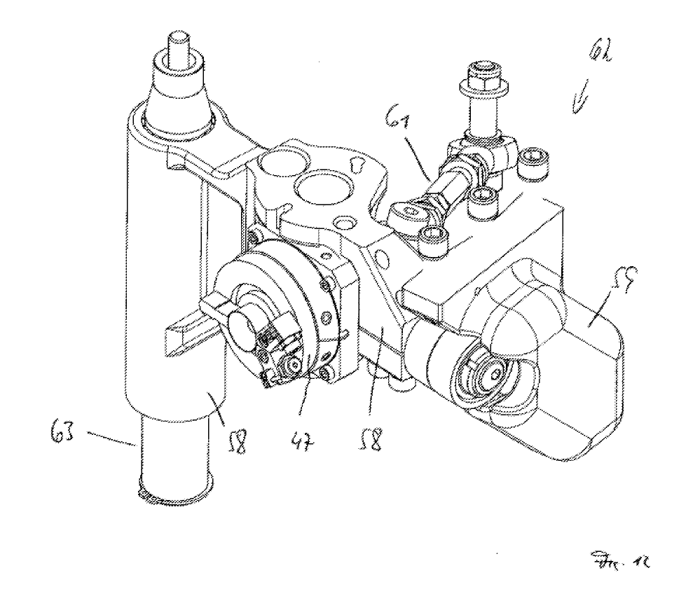

FIG. 12 The arrangement as per FIG. 11 after replacement of the manual lever by an automatically operable adjusting element.

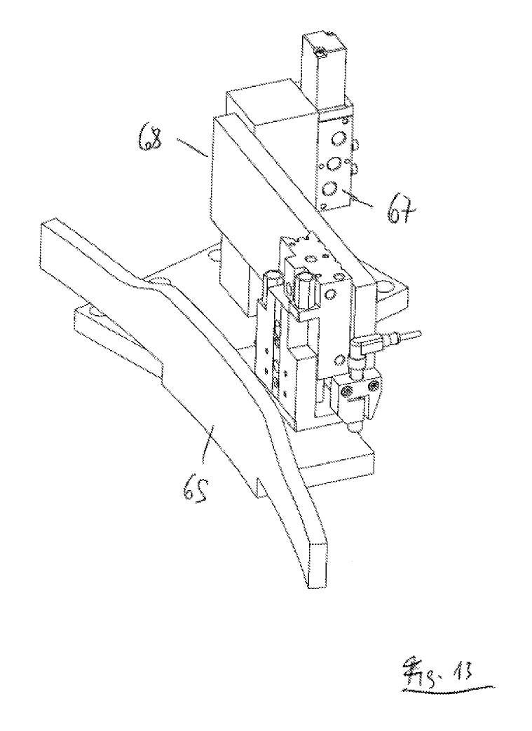

FIG. 13 A perspective view of a device with a curved segment that can be positioned for lifting and lowering a form.

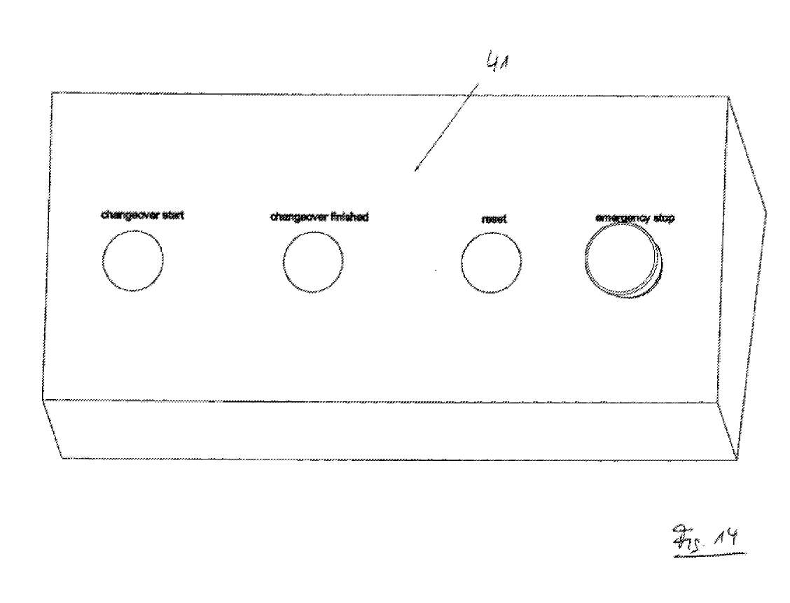

FIG. 14 A schematic perspective top-down view of the operating device depicted in FIG. 5 for facilitating changeout of the form without tools.

The main design of a device for reshaping of preforms (1) into containers (2) is depicted in FIG. 1 and in FIG. 2.

The device for shaping the container (2) essentially consists of a blowing station (3), which is equipped with a blow mold (4), into which a preform (1) can be inserted. The preform (1) can be an injection-molded part made of polyethylene terephthalate. To make it possible to insert the preform (1) into the blow mold (4), and to make it possible to remove the completed container (2), the blow mold (4) consists of form halves (5, 6) and a base part (7), which is able to be positioned by a lifting device (8). The preform (1) can be held in the area of the blowing station (3) by a transport mandrel (9), which, jointly with the preform (1), passes through a plurality of treatment stations within the device. However, it is also possible to insert the preform (1) by tongs, for example, or other handling devices, directly into the blow mold (4).

To make it possible to apply pressure, beneath the transport mandrel (9) an attaching piston (10) is placed, which feeds compressed air to the preform (1) and simultaneously seals it relative to the transport mandrel (9). In an altered design, however, it is in principle also conceivable to use fixed compressed air supply lines.

With this embodiment example, the preform (1) is stretched with the aid of a stretching rod (11) which is positioned by a cylinder (12). According to another embodiment form, the stretching rod (11) is mechanically positioned via curved segments which are impinged on by tapping rollers. Employing curved segments is especially appropriate if a plurality of blowing stations (3) is arranged on a rotating blow wheel.

In the embodiment form depicted in FIG. 1, the stretching system is configured so that a tandem arrangement of two cylinders (12) is provided. From a primary cylinder (13) the stretching rod (11) first is moved before the start of the actual stretching process to the area of a base (14) of the preform (1). During the actual stretching process, the primary cylinder (13), with a deployed stretching rod, is positioned jointly with a slide (15) bearing the primary cylinder (13) by a secondary cylinder (16) or via a curve guidance device. The particular thought herein is to make use of the secondary cylinder (16) in curve-guided fashion so that by a guide roller (17), which glides along a curved path when the stretching process is being carried out, a current stretching position is preset. The guide roller (17) is pressed by the secondary cylinder (16) against the guide path. The slide (15) glides along by two guiding elements (18).

After closing of the form halves (5, 6) arranged in the area of the carriers (19, 20), the carriers (19, 20) are locked relative to each other with the aid of a locking device (40).

For adapting a mouth section (21) of the preform (1) to various shapes, according to FIG. 2 provision is made to use separate threading inserts (22) in the area of the blow mold (4).

In addition to the blown container (2), drawn in on FIG. 2 in dashed lines is the preform (1), and also, schematically, a developing container bubble (23).

FIG. 3 shows the basic design of a blowing machine, which is equipped with a heating segment (24) and a rotating blow wheel (25). Proceeding from an input of preforms (26), the preforms (1) are transported by transport wheels (27, 28, 29) into the area of the heating segment (24). Along the heating segment (24), radiant heaters (30) and fans (31) are arranged, to provide heat treatment of the preforms (1). After the preforms (1) have been sufficiently heat-treated, these are passed to the blow wheel (25), in the area of which the blowing stations (3) are arranged. The already blown containers (2) are delivered by further transfer wheels to an output segment (32).

To be able to reshape a preform (1) into a container (2), so that the container (2) has material properties that ensure that the foodstuffs, especially drinks, filled within the container (2) will be able to be used over a long period, special procedural steps must be complied with during heating and orientation of the preforms(1). In addition, advantageous effects may be attained by complying with special guidelines for setting dimensions.

Various plastics can be used as thermoplastic material. For example, PET, PEN or PP can be employed.

The preform (1) is expanded during the orientation process by injection of compressed air. The supply of compressed air is divided in a pre-blowing phase in which gas, for example compressed air, is fed in at a low pressure level, and in a subsequent main blowing phase in which the gas is fed in at a higher pressure level. During the pre-blowing phase, typically the compressed air is used at a pressure in an interval from 10 bar to 25 bar, and during the main blowing phase compressed air it is fed in at a pressure in an interval from 25 bar to 40 bar.

Also perceptible from FIG. 3 is that with the depicted embodiment form, the heating segment (24) is formed from a plurality of circulating transport elements (33) that are in chain-like rows one next to the other, and are guided along deflection wheels (34).

Especially what is conceived of there is, through the chain-like arrangement, to set an essentially rectangular base contour. In the embodiment form depicted, in the area of the extension of the heating segment (24) that faces the transport wheel (29) and an input wheel (35), a deflection wheel (34) of relatively large dimension, and in the area of the adjoining deflections, two deflection wheels (36) with relatively smaller dimensions, are used. However, in principle any other guidance devices are conceivable.

To make it possible to place the transport wheel (29) and the input wheel (35) relative to each other so as to adjoin as tightly as possible, the depicted arrangement proves to be especially appropriate, since in the area of the corresponding extension of the heating segment (24) three deflection wheels (34, 36) are positioned, and in particular the smaller deflection wheels (36) in the area of the transition to where the heating segment (24) runs in linear fashion and the larger deflection wheel (34) in the immediate area of transition to the transport wheel (29) and to the input wheel (35). As an alternative to use of chain-like transport elements (33) it is for example also possible to employ a rotating heating wheel.

After the containers (2) have been blown to completion, they are taken out by a removal wheel (37) from the area of the blowing stations (3) and transported via the transport wheel (28) and a release wheel (38) to the release segment (32).

In the modified heating segment (24) depicted in FIG. 4, via the larger number of radiant heaters (30), a larger number of preforms (1) can be heat-treated per unit of time. Here the fans (31) direct cooling air into the area of cooling air channels (39), which lie opposite the assigned radiant heaters (30) and release cooling air via ejection openings. Through the arrangement of ejection openings, a flow direction is implemented for the cooling air essentially transverse to a transport direction of the preforms (1). The cooling air channels (39) can also make available reflectors for the thermal radiation in the area of the surfaces opposite the thermal radiators (30); it is likewise possible via the emitted cooling air to implement cooling of the radiant heaters (30).

FIG. 5 is a perspective depiction of the blow wheel (25) with three already-mounted blowing stations (3). Also perceived is an operating device (41) to start the beginning of a form changeover without tools and to end this operating procedure. In addition, a curved segment (42) able to be positioned is recognizable, which, in an operational position, presets an opening of the blowing station (3) when the blowing wheel (25) makes a rotational movement. The curved segment (42) can be positioned pneumatically, for example. FIG. 5 also shows the placement of two ID units (43, 44). For example, units (43, 44) can identify the blow mold (4) or parts of the blow mold (4) and transmit appropriate information to the machine control device. It can for example be identified through mechanical coding, by a transponder or other identification elements that can for example be detectable electrically or optically.

For example, the identification can check the matching of individual form parts and/or to check whether the form parts correspond to a production version selected via the machine control device.

Also drawn in on FIG. 5 is a curve segment (65) able to be positioned, which positions a blow nozzle relative to blow mold (4). The curve segment (65) in question is explained in still greater detail in connection with FIG. 13.

FIG. 6 is a perspective depiction of two exterior shell molds, which are provided for assembly in the area of the carriers (19, 20). One or more adjusting elements (47) are arranged at the side on exterior shell molds (45, 46). The adjusting elements (47) can be configured as pneumatic cylinders and do positioning of a fastening element not shown in FIG. 6 for fixing of interior shell molds, likewise not shown, relative to the exterior shell molds (45, 46).

FIG. 7 is a perspective depiction of a fastening element (48) for fixing of the interior shell molds. Here the fastening element is coupled with an adjusting element which is configured as a manual lever (49). Here the manual lever is configured as a rocker arm, which manually positions the fastening element (48) in a longitudinal direction (50), hereby undertaking a fixing of the interior shell mold or releasing it again.

In the embodiment example shown, the manual lever (49) is designed as a knee lever, which exhibits a locking bolt (51).

FIG. 8 is an exterior perspective depiction of an interior shell mold (52). Also perceptible is a base part (7) of the blow mold (4), which is equipped with a multiple coupling (53). The multiple coupling (53) feeds at least one heating or cooling medium to the base part (57).

FIG. 9 is a perspective depiction of two exterior shell molds (45, 46) with two assigned interior shell molds (52). Again adjusting elements (47) are to be seen.

A lifting mechanism (54) is provided for positioning of the base part (7).

In addition, a distributor block (55) is recognizable for cold water and hoses (56) for the blowing station (3).

FIG. 10 clarifies the design of a blowing station (3), in which a knee lever is used for opening and closing the blowing station (3). Also perceived are the form carriers (19, 20) along with the exterior shell molds (45, 46).

For positioning of the base part (7) a slide (58) is used. The slide (58) is positioned using a curve (59).

The blowing station (3) carries out opening and closing motions while employing a curve roller (60). The motion of the base form (7) and the opening motion of the carriers (19, 20) are coupled while using a coupling lever (61).

FIG. 11 shows a fastening device for the base form (7) that is loosened and fixed without tools. Here an adjusting element (47) is configured as a manually operable hand lever. Also to be perceived are the slide (58) and an axle (63) for positioning of the base form (7). A locking bolt (64) is employed for presetting the retention of a selected locked or loosened state.

FIG. 12 shows a variation of the embodiment form in FIG. 11. According to the embodiment form in FIG. 12, the adjusting element (47) is configured as a pneumatic pivoting cylinder. Preferably as a pivoting cylinder with a limit switch.

FIG. 13 shows a curve segment (65) for positioning a blow nozzle. The curve segment (65) is able to be positioned by an adjusting element (66). The adjusting element (66) can be a manual adjusting device; with the embodiment example depicted, a pneumatic adjustment is used that is governed by a valve (67). The valve (67) as well as the pneumatic adjusting element (66) are suitably positioned by a holder (68).

FIG. 14 shows the control device (41) with four control buttons. One control button is provided to start the changeover process and another control button is provided to finish the changeover process. In addition, there is a control button to carry out a reset and for an emergency stop.

Typically parts of the blow mold (4) or the entire blow mold (4) are changed out in that at least in a provided operating position, access is provided for an operator to the blow wheel (25), for example by opening a door in the machine covering. Then the curve segment for opening the blowing station (39) is positioned manually or automatically so that when the blow wheel (25) is turned, the blowing station (3) is opened in the area of the working position of the operator. Typically, simultaneous to opening the blowing station (3), the base form (7) is positioned, for example by mechanical coupling with the opening movement of the blowing station (3).

Simultaneous to the positioning of the curve segment of the blowing station (3), the curve segement (65) is also suitably placed for positioning of the blow nozzle. Then preferably the blow wheel (25) is moved forward in timed fashion, so that one after the other the individual blowing stations are positioned, opened, in the area of the operator. By manual unlockings, the operator can then actuate manual fastening elements; if with an automatic unlocking, pneumatic cylinders, hydraulic cylinders or electric motors unlock the parts of the blow mold (4) to be removed. Then the operator can remove the part of the blow mold (4) in question and change it out with another part provided. After insertion of the new blow mold part, the processes described occur in reverse order.

According to one embodiment example, the individual handling processes of the operator are facilitated optically by illumination of the elements to be operated. For example, with a so-called laser pointer or with a light spot.

1. A method for blow molding of containers, in which preforms, after thermal conditioning, are reshaped into the containers by blowing pressure within a blow mold of a blowing station of a blow molding machine, and where for the adjustment to a contour of the containers to be produced, at least a part of a first blow mold is removed from the blowing station and is replaced by at least a part of a second blow mold, and wherein before removal of the part of the first blow mold, a fastening that fixes the part of the first blow mold to the blowing station is unlocked, and after insertion of the part of the second blow mold, said fastening is again positioned for fixing the part of the second blow mold to the blowing station, and wherein said fastening is coupled with an adjusting element.

2. The method according to claim 1, wherein the blowing station is opened before the fastening is unlocked.

3. The method according to claim 1, wherein the blowing station is opened during a turning motion of the blow wheel by positioning a curve segment manually or automatically so that when the blow wheel is turned, the blowing station is opened.

4. The method according to claims 1, wherein before the fastening is unlocked a blow nozzle is positioned.

5. The method according to claim 4, wherein the blow nozzle is positioned during a turning motion of the blow wheel by positioning a curve segment so that when the blow wheel is turned, the blow nozzle is positioned.

6. The method according to claim 1, wherein a fastening of a base form is unlocked.

7. The method according to claim 6, wherein the base form is connected via at least one coupling with at least one operating material supply.

8. The method according to claim 1, wherein a support for the base form is mechanically coupled with form carriers of the blowing station so that a motion coupling is implemented.

9. The method according to claim 1, wherein the adjusting element is manually actuated.

10. The method according to claim 1, wherein the adjusting element is actuated by a controllable actuator.

11. A device for blow molding of containers that comprises at least one blowing station with a blow form, wherein the blow mold consists of at least two parts that can be fixed by at least one fastening in an area of the blowing station, wherein the fastening is coupled with at least one actuating mechanism, wherein the fastening is coupled with an adjusting element.

12. The device according to claim 11, wherein adjacent to the blow wheel a positionable curve segment is placed for presetting an opening of the blower station.

13. The device according to claim 11, wherein adjacent to the blow wheel a positionable curve segment is placed for presetting a positioning of the blow nozzle.

14. The device according to claim 11, wherein the base form exhibits at least one coupling for connection to an operating material supply.

15. The device according to claim 11, wherein a support of the base form is mechanically coupled with carriers of the blow mold.

16. A method for adjusting a contour of containers produced by blow molding in which thermally conditioned preforms are reshaped into containers by blowing pressure within a blow mold of a blowing station of a blow molding machine, the method comprising:
unlocking a fastening that fixes at least a part of a first blow mold to the blowing station;
removing the part of the first blow mold from the blowing station;
replacing the part of the first blow mold with at least a part of a second blow mold; and
relocking the fastening such that it fixes the part of the second blow mold to the blowing station;
wherein said fastening is coupled with an adjusting element that allows the removal of the first part of the blow mold and replacement of the second part of the blow mold without using tools.
